(19) United States
(12) Patent Application Publication
(10) Pub. No.: US 2009/0287526 A1
(43) Pub. Date: Nov. 19, 2009

(54) DYNAMIC WORK ALLOCATION SYSTEM FOR TRANSACTION PROCESSING

(76) Inventors: Nithya Ramkumar, Bangalore (IN); Umakant Soni, Bangalore (IN); Akshay Mohan, Cambridge, MA (US); Amit Vikram, Bangalore (IN); T K Kurien, Bangalore (IN); Arundat Mercy Dasari, Bangalore (IN)

Correspondence Address: Global IP Services, PLLC, 3rd Block, 198 F.27th Cross, Jayanagar, 560011, IN

(21) Appl. No.: 12/119,511

(22) Filed: May 13, 2008

(51) Int. Cl. G06Q 10/00

(52) U.S. Cl. 705/9; 705/7

(57) ABSTRACT

A dynamic work allocation system and method is disclosed. In one embodiment, a method includes dynamically classifying jobs into job lists according to a predetermined classifying process by a collecting engine, a controlling engine, and a monitoring engine, dynamically prioritizing the jobs within each job list of the jobs lists into an ordered job list according to a predetermined prioritizing process by the collecting engine, the controlling engine, the monitoring engine, a diagnosing engine, a learning engine, and a predicting engine, and dynamically mapping the jobs in the ordered job list to agents according to a predetermined mapping process by the collecting engine, the controlling engine, the monitoring engine, the diagnosing engine, the learning engine, and the predicting engine. The method may include dynamically collecting of a job of the jobs and/or information associated with the job of the jobs by the collecting engine and the controlling engine.

### FIELD OF THE INVENTION

The present invention relates to business processing, and more specifically to a dynamic work allocation system and method.

### BACKGROUND

In business process execution, a major challenge is found in allocating resources to a job set as per the processes. The resources available within a process need to be continuously mapped and remapped to the job set as the business process execution conditions change dynamically and in real time. The mapping and remapping of resources is essential to meet predefined service level agreement requirements and to ensure satisfaction of an end user of the business execution.

Further, an issue faced by an operations team executing an outsourced business process is the right allocation of jobs to agents to maximize the probability of meeting client expectations.

Specifically, companies that outsource their business processes expect the execution of the outsourced services to be consistent to a predefined level of service, i.e., to meet or exceed service level agreement parameters, such as metrics for a defined turnaround time and quality objectives.

### BRIEF DESCRIPTION OF THE DRAWINGS

Example embodiments are illustrated by way of example and not limitation in the figures of the accompanying drawings, in which like references indicate similar elements and in which:

FIG. 1 illustrates a high level block diagram showing relationship between an autonomic business platform and a dynamic work allocation system, according to one embodiment.

FIG. 2 illustrates a dynamic work allocation system, according to one embodiment.

FIG. 3 illustrates relationship between various engines of the autonomic business process platform and different steps of the dynamic work allocation system shown in FIG. 2, according to one embodiment.

FIG. 4 is a block diagram illustrating various modules associated with the dynamic work allocation system, according to one embodiment.

FIGS. 5A and 5B illustrate performance related to the collecting engine in the dynamic work allocation system in relationship with other engines of the autonomic business process platform, according to one embodiment.

FIGS. 6A and 6B illustrate performance related to the monitoring engine in the dynamic work allocation system in relationship with other engines of the autonomic business process platform, according to one embodiment.

FIGS. 7A and 7B illustrate performance related to the diagnosing engine in the dynamic work allocation system in relationship with other engines of the autonomic business process platform, according to one embodiment.

FIGS. 8A and 8B illustrate performance related to the controlling engine in the dynamic work allocation system in relationship with other engines of the autonomic business process platform, according to one embodiment.

FIGS. 9A and 9B illustrate performance related to the predicting engine in the dynamic work allocation system in relationship with other engines of the autonomic business process platform, according to one embodiment.

FIGS. 10A and 10B illustrate performance related to the learning engine in the dynamic work allocation system in relationship with other engines of the autonomic business process platform, according to one embodiment.

FIGS. 11A and 11B are block diagrams illustrating different job/task status in a system, according to one embodiment.

FIG. 12 illustrates a diagrammatic system view of a data processing system in which any of the embodiments disclosed herein may be performed, according to one embodiment.

FIG. 13A is a process flow of dynamically allocating work in a data processing system, according to one embodiment.

FIG. 13B is a continuation of the process flow of FIG. 13A, illustrating additional processes, according to one embodiment.

Other features of the present embodiments will be apparent from the accompanying drawings and from the detailed description that follows.

### DETAILED DESCRIPTION

A dynamic work allocation system and method is disclosed. In the following description, for purposes of explanation, numerous specific details are set forth in order to provide a thorough understanding of the various embodiments. It will be evident, however, to one skilled in the art that the various embodiments may be practiced without these specific details.

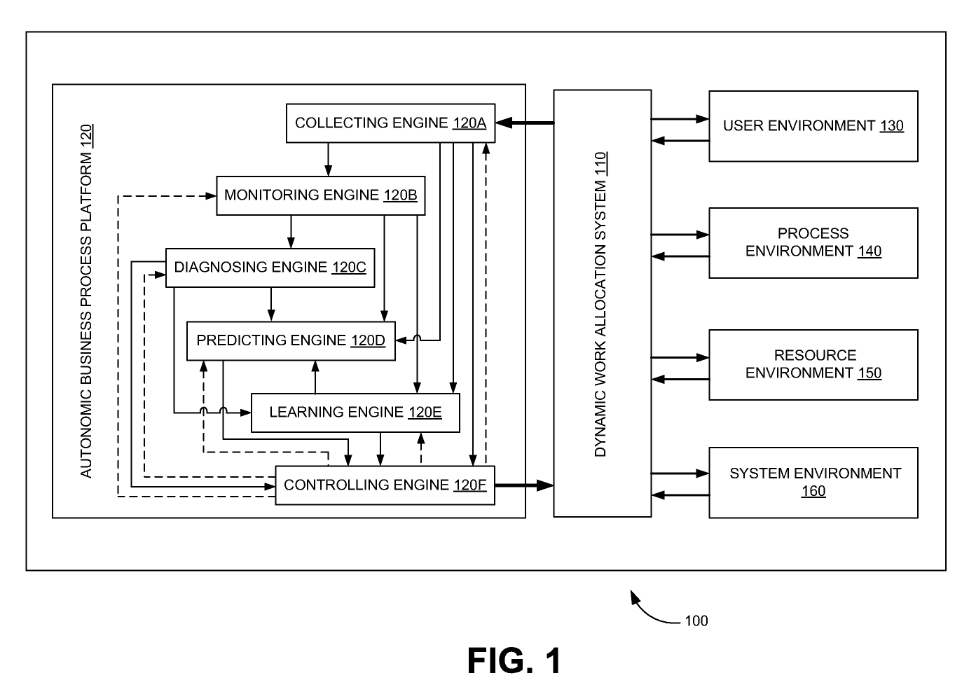

FIG. 1 illustrates a high level block diagram 100 showing relationship between an autonomic business platform 120 and a dynamic work allocation system 110, according to one embodiment. Particularly, FIG. 1 illustrates the autonomic business process platform 120 having a collecting engine 120A, a monitoring engine 120B, a diagnosing engine 120C, a predicting engine 120D, a learning engine 120E and a controlling engine 120F coupled to the dynamic work allocation system 110 for dynamically allocating jobs to agents.

In operation, the collecting engine 120A collects all or a part of jobs coming into the dynamic work allocation system 110. The collecting engine 120A also collects information related to the jobs and other information necessary to optimize allocation of the jobs to right agents for processing. The monitoring engine 120B gets input from the collecting engine 120A and monitors data related to process, people, system and job received from the collecting engine 120A.

In one embodiment, the monitoring engine 120B measures the data periodically against a threshold predefined in a system. For example, one of the data flows which the monitoring engine 120B monitors is the changing status of the jobs. The status may include a completed job, a work in progress job, a new job, a quality checked job, a quality check in progress job, a quality pass job, a quality failed job, a rework job, a reject job, etc. It can be noted that the changing status of the jobs is one of the critical inputs for the diagnosing engine 120C (as well as for the predicting engine 120D and the learning engine 120E). The diagnosing engine 120C uses the changing status of the jobs as an input to identify positive and negative reasons for the change. This analysis feeds into the predicting engine 120D and/or the learning engine 120E to allow the system to learn and predict plausible future outcomes.

In another embodiment, the monitoring engine 120B monitors mapping of the jobs to an available agent pool. In this embodiment, the monitoring engine 120B feeds mapping information into the diagnosing engine 120C as well as the predicting engine 120D and/or the learning engine 120E. As shown in FIG. 1, the predicting engine 120D and the learning engine 120E take input data from the diagnosing engine 120C, the monitoring engine 120B and the collecting engine 120A. In some embodiments, the input data is used to predict the plausible outcomes in the process and recommend actions to improve the process further.

In addition, the learning engine 120E feeds on historical data generated by the system. In one embodiment, the learning engine 120E identifies factors leading to an efficient and optimized work allocation. In addition, the learning engine 120E can identify factors such as most relevant skills required for performing a job type. It can be noted that the predicting engine 120D may use such an input to accurately identify resource requirements across people, process, system, etc., if a certain set of jobs arrive into the system for processing.

In some embodiments, the predicting engine 120D along with the learning engine 120E can also project constraints, the system may face in a defined future period based on the learnings from past and current data. Such an output from the learning engine 120E and the predicting engine 120D forms one of the inputs which the controlling engine 120F relies on along with the information from the collecting engine 120A to generate an optimized work allocation.

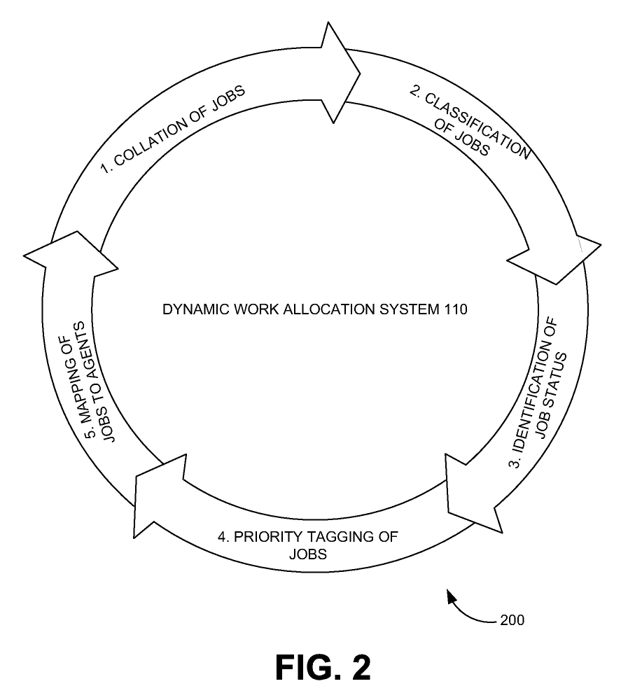

FIG. 2 illustrates a dynamic work allocation system 200, according to one embodiment. Particularly, FIG. 2 illustrates various steps of dynamic work allocation including collation of jobs, classification of jobs, identification of job status, priority tagging of jobs, and mapping of jobs to agents. The following steps are involved in distributing the jobs to the agents. The first step in the dynamic work allocation is collating the jobs to obtain a job set. During this step, the collecting engine 120A collects jobs from one or more sources, e.g., defined sources including fresh jobs coming into the system and the jobs already being processed in the system which require re-allocation. In some embodiments, information related to the jobs (and any other information necessary to optimize the allocation of the jobs to the agents for processing) is collected in the process.

The second step in the dynamic work allocation is classification of jobs. It can be noted that execution of business processes may require certain classifications of the jobs or identification of certain attributes on the jobs which may help in the processing of the jobs. In some embodiments, the dynamic work allocation system 110 identifies the predefined classification parameters and then classifies the jobs associated with the process into defined job queues to be processed according to the predefined classification parameters. For example, the predefined classification parameters includes region of origin of the job, monetary value of job, type of job, etc.

The classified jobs are then identified according to status of each job. During the identification process the status of jobs is identified by the dynamic work allocation system 110 which aids in automatic rule based prioritization of the jobs at the time of allocation of jobs for processing. In one example embodiment, the dynamic work allocation system 110 may identify the job status as a completed job, a work in progress job, a new job, a quality checked job, a quality check in progress job, a quality pass job, a quality failed job, a rework job, a reject job, etc. The built in process rules would automatically use the status of the job in determining a demand factor for each individual job, based on a defined computation method.

Further, the dynamic work allocation system 110 performs a rule-based prioritization of jobs based on pre-configured requirements of the process and the real time changes in the priority requirements for the jobs. In one embodiment, the identified, classified jobs are priority tagged according to rule-based priorities. In some embodiments, the relative importance of each job of the jobs is determined with respect to one another. In these embodiments, the dynamic work allocation system 110 assigns a value Di to each job based on determination of relative importance of each job with respect to one another (and may be irrespective of which job queue the particular job might lie in). Further, the jobs are arranged according to the relative value Di of each job of the jobs. For example, the Di value takes into account both the job related parameters and queue related parameters. Once the jobs have a priority tag attached to them, the jobs are stacked in descending order of priority and become part of a common pool of prioritized job set available for allocation to agents in the business process. In one example embodiment, Di is defined as Di=Dj+Dq, where Dq takes the values defining priority of pre-defined job queues and Dj takes the values defining priority of individual jobs. Further, Dj may be based on defined parameters like job priority, job ageing priority, rework priority, restart priority, reject priority, etc.

Further, the priority tagged jobs are mapped to the agents. In this process, the mathematical algorithm in the dynamic work allocation system 110 allocates the prioritized un-allocated jobs among available pool of agents taking into account both demand side and supply side parameters. The demand side parameters relate to the job and client requirements for processing of jobs. The supply side parameters relate to the agent and the resources being provided for processing of the jobs. In one embodiment, the mapping of jobs to agents in the dynamic work allocation system 110 is based on identification of authorization matrix for an agent and allocation of work to the agent.

The following explanation describes the identification of authorization matrix for each agent. In a pull based methodology implemented in the dynamic work allocation system 110, when an agent requests or pulls job, the dynamic work allocation system 110 identifies which team the agent is associated with. For example, the agent may be associated with one or more than one team in one or more than one process. Based on the teams associated with the agent, the dynamic work allocation system 110 identifies process, sub-process and/or an activity in which the team is authorized to work. The dynamic work allocation system 110 identifies a process or an activity assigned to the agent in each team and in each process. This allows the dynamic work allocation system 110 to identify a list of processes, sub-processes, and/or categories and process roles (sometimes collectively referred to herein as “processes”), the agent is authorized to work on.

In one example embodiment, the dynamic work allocation system 110 may identify a certain process, a set of sub-processes based on monetary value of the job, and may identify whether the agent is authorized to work on high value jobs or low value jobs. The authorization may be based on the input from the initial configuration of the dynamic work allocation system 110 for a process in which the dynamic work allocation system 110 is configured to allow only a set of jobs based on, but not limited to some defined parameters like monetary value of job within a particular process to be accessible to an agent for processing. Further, the authorization may also be based on agent parameters like but not limited to, skill level of the agent, efficiency level of the agent, availability of the agent, etc.

In the allocation of jobs to agents step, the dynamic work allocation system 110 allocates a job from the common pool of prioritized set of jobs which is already determined, based on the demand factor of each individual job. When the agent pulls the job from the dynamic work allocation system 110, the dynamic work allocation system 110 narrows down list of available jobs to a list of jobs for which the agent is authorized to work on, in the given process. In this set of jobs, the dynamic work allocation system 110 determines the job which has the highest demand factor and allocates that job to the agent.

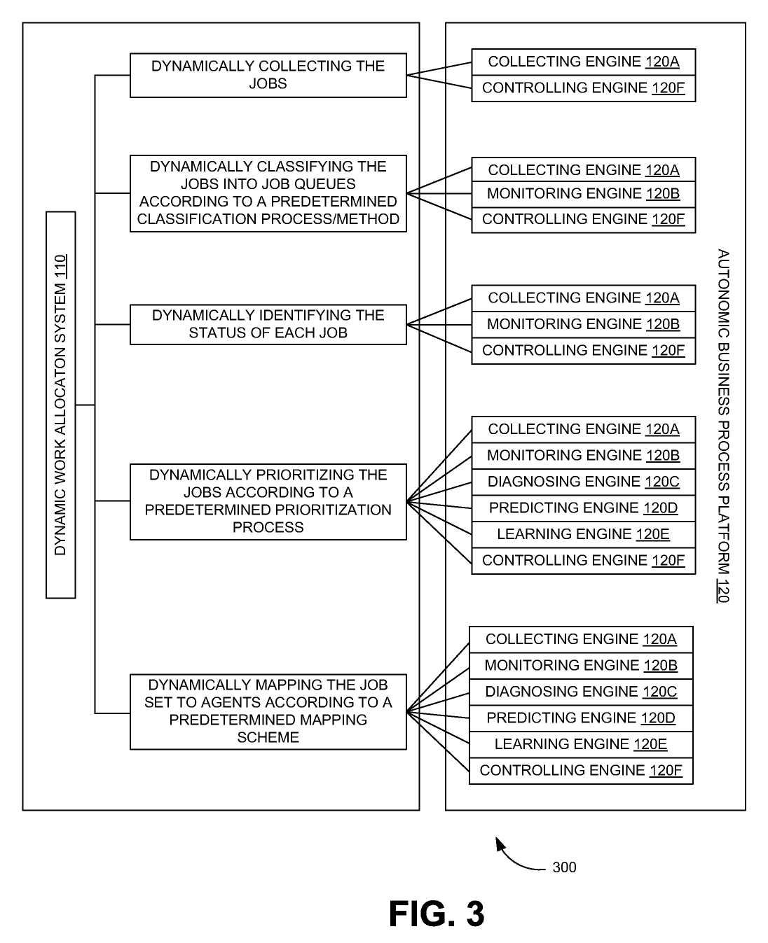

FIG. 3 illustrates relationship between the various engines of the autonomic business process platform 120 and different steps of the dynamic work allocation system 110 shown in FIG. 2, according to one embodiment. In one embodiment, the collecting engine 120A, the monitoring engine 120B, the diagnosing engine 120C, the predicting engine 120D, the learning engine 120E, and the controlling engine 120F of the autonomic business process platform 120 enable the dynamic work allocation system 110 to dynamically allocate the jobs to agents in a manner described below.

In the example embodiment illustrated in FIG. 3, job(s) and/or information associated with the job(s) is dynamically collected by the collecting engine 120A and/or the controlling engine 120F. Further, the jobs are dynamically classified into job lists according to a predetermined classifying process by the collecting engine 120A, the monitoring engine 120B and/or the controlling engine 120F. In addition, the collecting engine 120A, the monitoring engine 120B and/or the controlling engine 120F also enable dynamically identifying a status associated with each job. For example, the status includes a completed job, a work in progress job, a new job, a quality checked job, a quality check in progress job, a quality pass job, a quality failed job, a rework job, a reject job, etc. Based on the status, the jobs within each job list of the job lists is dynamically prioritized into an ordered job list according to a predetermined prioritizing process by the collecting engine 120A, the monitoring engine 120B, the diagnosing engine 120C, the predicting engine 120D, the learning engine 120E and/or the controlling engine 120F.

Further, it can be seen from FIG. 3 that the dynamic mapping of the jobs in the ordered job list to agents according to a predetermined mapping process is accomplished by the collecting engine 120A, the monitoring engine 120B, the diagnosing engine 120C, the predicting engine 120D, the learning engine 120E and/or the controlling engine 120F. In some embodiments, availability of each agent of the agents is dynamically determined. In these embodiments, based on the availability of the agents, the jobs in the ordered job list are dynamically mapped to the agents according to the predetermined mapping process by the collecting engine 120A, the monitoring engine 120B, the diagnosing engine 120C, the predicting engine 120D, the learning engine 120E and/or the controlling engine 120F.

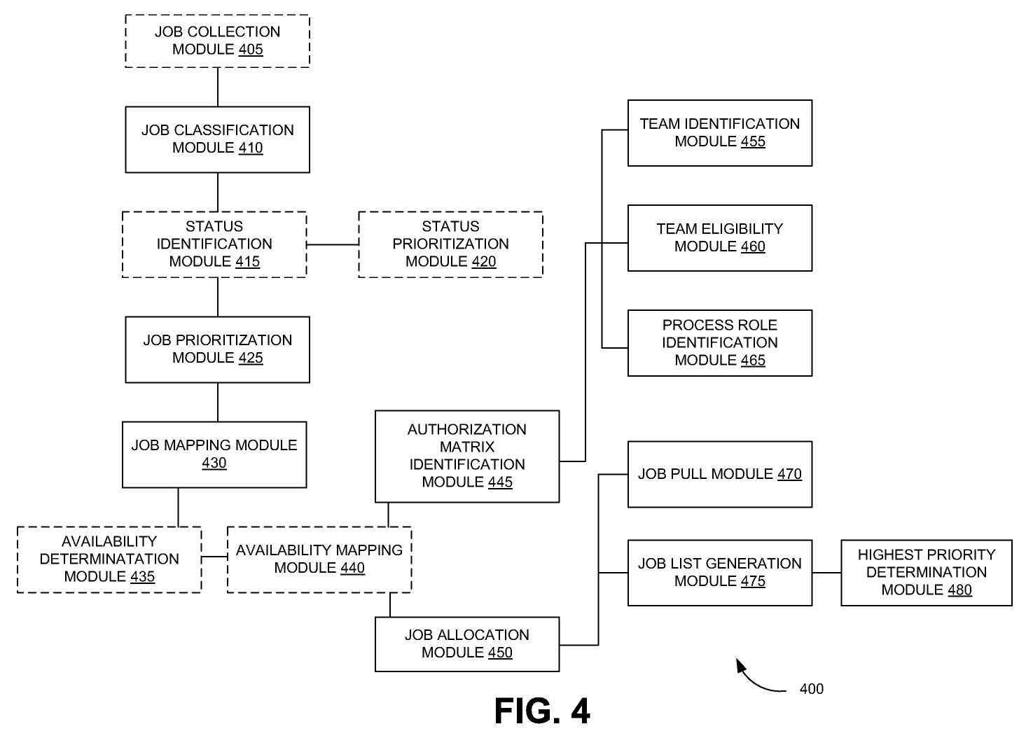

FIG. 4 is a block diagram 400 illustrating various modules associated with the dynamic work allocation system 110, according to one embodiment. Particularly, FIG. 4 illustrates a job collection module 405, a job classification module 410, a status identification module 415, a job prioritization module 425, a job mapping module 430, and an availability determination module 435. As shown in FIG. 4, the availability determination module 435 includes an availability mapping module 440. Further, the availability mapping module 440 includes an authorization matrix identification module 445 and a job allocation module 450.

In operation, the job collection module 405 dynamically collects a job of jobs and information associated with the job by the collecting engine 120A and/or the controlling engine 120F. The job classification module 410 dynamically classifies the jobs into job lists according to a predetermined classifying process by the collecting engine 120A, the monitoring engine 120B, and/or the controlling engine 120F. The status identification module 415 dynamically identifies a status associated with each job of the jobs by the collecting engine 120A, the monitoring engine 120B and/or the controlling engine 120F.

For example, the status includes a completed job, a work in progress job, a new job, a quality checked job, a quality check in progress job, a quality pass job, a quality failed job, a rework job, and a reject job. In these embodiments, a status prioritization module 420 dynamically prioritizes, based at least in part on the statuses, the jobs within each job list into an ordered job list according to a predetermined prioritizing process by the collecting engine 120A, the monitoring engine 120B, the diagnosing engine 120C, the predicting engine 120D, the learning engine 120E and/or the controlling engine 120F.

In one embodiment, the job prioritization module 425 dynamically prioritizes the jobs within each job list into an ordered job list according to a predetermined prioritizing process by the collecting engine 120A, the monitoring engine 120B, the diagnosing engine 120C, the predicting engine 120D, the learning engine 120E, and/or the controlling engine 120F. The job mapping module 430 dynamically maps the jobs in the ordered job list to agents according to a predetermined mapping process by the collecting engine 120A, the monitoring engine 120B, the diagnosing engine 120C, the predicting engine 120D, the learning engine 120E, and/or the controlling engine 120F.

In one embodiment, the availability determination module 435 dynamically determines availability of each agent of the agents. In this embodiment, the availability mapping module 440 dynamically maps, based at least in part on the availability of the agents, the jobs in the ordered job list to agents according to a predetermined mapping process, by the collecting engine 120A, the monitoring engine 120B, the diagnosing engine 120C, the predicting engine 120D, the learning engine 120E, and/or the controlling engine 120F. Further, the authorization matrix identification module 445 of the availability mapping module 440 dynamically identifies an authorization matrix for an agent.

As shown in FIG. 4, a team identification module 455, a team eligibility module 460, and a process role identification module 465 are associated with the authorization matrix identification module 445. The team identification module 455 dynamically identifies a team associated with the agent of the agents. The team eligibility module 460 dynamically ascertains team eligibility of processes, sub-processes, and/or categories. The process role identification module 465 dynamically identifies a process role assigned to the agent of the agents.

In one embodiment, the job allocation module 450 dynamically allocates job(s) to an agent of the agents based on the authorization matrix for the agent of the agents. Further, as shown in FIG. 4, a job pull module 470 and a job list generation module 475 (having a highest priority determination module 480), are associated with the job allocation module 450. The job pull module 470 dynamically pulls, via an authorized agent of the agents, an allocated job of the jobs. The job list generation module 475 dynamically generates a list of jobs on which the agent of the agents is authorized to work, based on the authorization matrix associated with the agent of the agents and the current prioritized jobs. The highest priority determination module 480 dynamically determines which job in the list of jobs has a highest priority associated with a priority tag of the job in the jobs list.

In accordance with one or more embodiments described above, the dynamic work allocation system 110 operates using principles of pull-based activity allocation i.e., the dynamic work allocation system 110 does not reserve an activity for a particular agent and/or a user. The activity gets initiated by a particular user upon a request (e.g., pull) by the user and also gets locked for that particular user.

In some embodiments, the dynamic work allocation system 110 is configured prior to allocation of the jobs to the agents. The configuration of the dynamic work allocation system 110 allows business rules to be built into the dynamic work allocation system 110 which control the work allocation process. For example, the business rules being defined may be at a system level, a process level, a resource level and/or a job level.

In one example embodiment, the dynamic work allocation system 110 may be configured to allow only the agent to have authorization to request work in the process. Further, the dynamic work allocation system 110 may also be configured to allow only a set of processes from which the agent can request or pull work for processing. The dynamic work allocation system 110 may also be configured to allow only a set of jobs, based on some defined parameters like monetary value of the job within a particular process to be accessible to the agent for processing.

In one example embodiment, the dynamic work allocation system 110 may take into account agent parameters like skill level of agents, efficiency level of agents related to particular jobs, authorization of agents to work on particular jobs, availability of agents, etc. when determining access rights for agents to work on the available job set. It can be noted that configuration of the dynamic work allocation system 1 10 is a not a periodic process and is performed at the beginning of the process and then later on, it is performed as and when required, based on the process requirements.

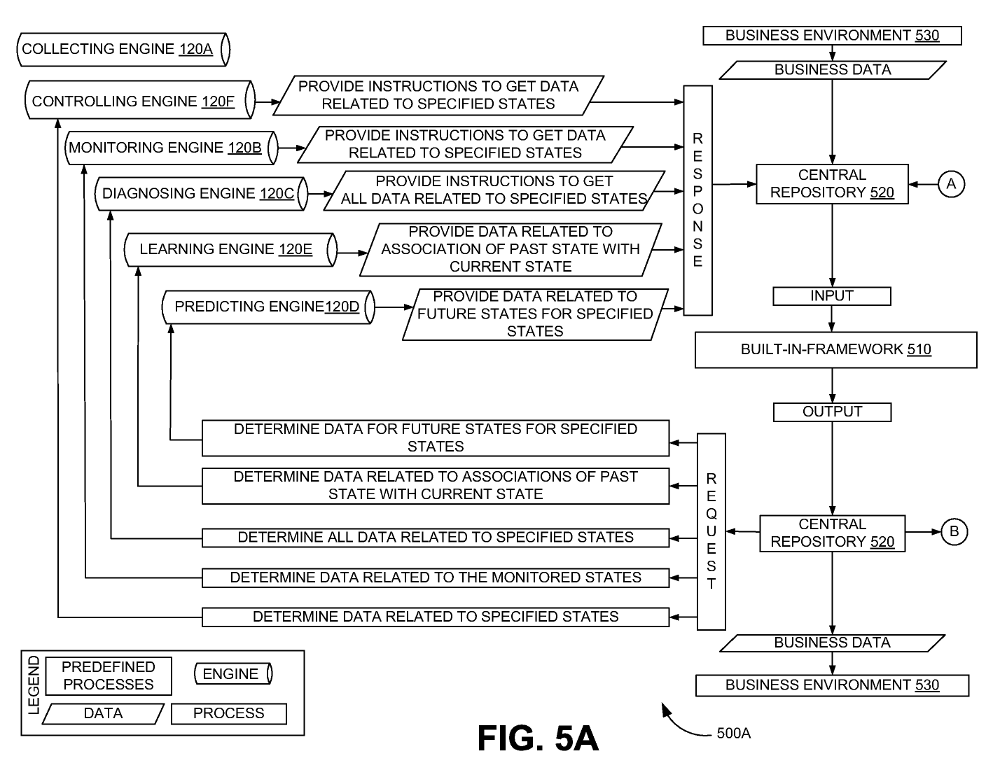

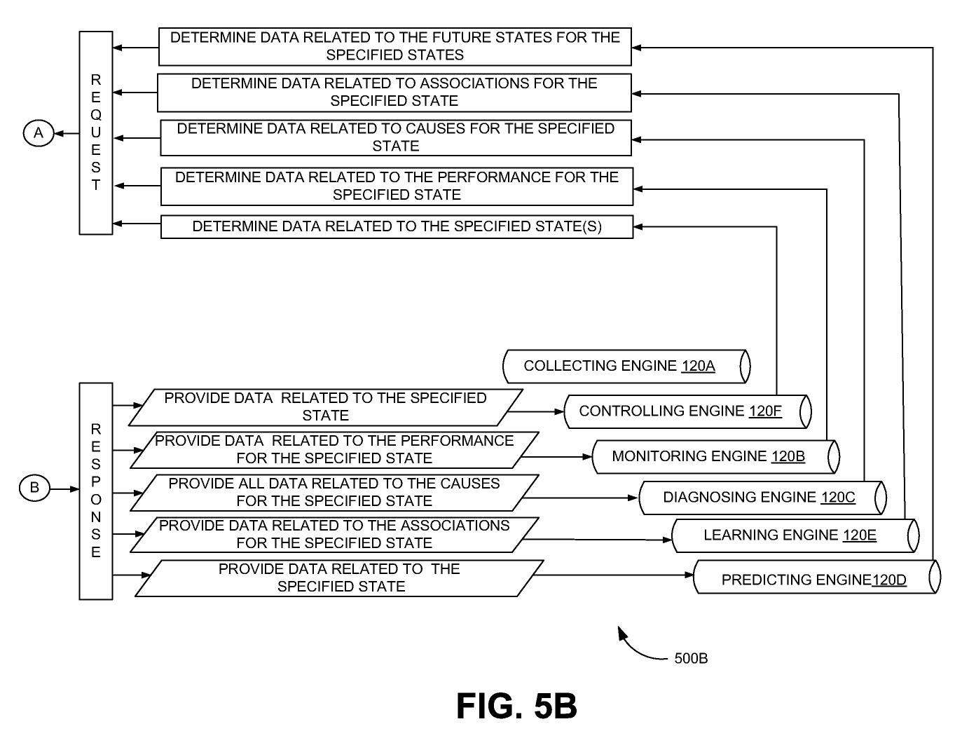

FIGS. 5A and 5B illustrate performance related to the collecting engine 120A in the dynamic work allocation system 1 10 in relationship with other engines of the autonomic business process platform 120, according to one embodiment. Particularly, FIG. 5A illustrates a built-in-framework 510 associated with the dynamic work allocation system 110 that interacts with a central repository 520 to collate business data (e.g., system data, process data, resource data and people data) from various sources (e.g., user environment 130, process environment 140, system environment 150, resource environment 160 of FIG. 1) of a specified state.

The central repository 520 includes data which is accessed by the various engines of the autonomic business process platform 120 to perform different functions. In one embodiment, the business data includes data that is inputted to the central repository 520 or delivered to business environment 530 by the central repository 520 for dynamic allocation of jobs to agents. In one example embodiment, the business environment 530 provides a business context of operation of the autonomic business process platform 120 which includes business objectives and overall constraints, requirements and expectations from the user environment 130, the process environment 140, the system environment 150, the resource environment 160, and the autonomic business process platform 120.

The collecting engine 120A of the autonomic business process platform 120 enables automatic collection from different sources, data associated with at least one state of the systems, at least one state of the resources, at least one state of the persons and/or at least one state of the processes. The data collected may be part or all of the data necessary to optimally perform as specified by the process environment 140. For example, the data may be real-time, periodic, non-periodic, local or global process data and may be used by the user environment 130, the process environment 140, the system environment 150 and the resource environment 160.

Further, the data may include aggregated or individual elements and is disseminated to systems and people involved in execution and management of the combination of any of the engines including but not limited to the monitoring engine 120B, the diagnosing engine 120C, the predicting engine 120D and the learning engine 120E.

The collecting engine 120A may operate through a rules-based method or any other method including but not limited to a neural network to collect data and/or metrics related to specified variables related to the specified state. Based on these rules, automatic and near real-time notifications are generated by the system. For example, the notifications may include but not limited to alerts on inadequacy of data, pre-emptive alerts on inadequacy of data, and other issues related to the collecting of data.

The collecting engine 120A may collect data on specified variables characterizing specified state, based on requests received from the other engines of the autonomic business process platform. For example, the collecting engine 120A may use request of the controlling engine 120F of the autonomic business process platform 120 as an input to collect data and/or metrics related to the specific variables characterizing the specified state. In some embodiments, the collecting engine 120A may collect data and/or metrics related to specified variables, based on the requests raised by the collecting engine 120A on the other engines of the autonomic business process platform 120.

For example, the collecting engine 120A may raise requests on the controlling engine 120F of the autonomic business process platform 120 to determine relevant data related to the system, the resource, the process and/or the person for a specified state. The collecting engine 120A may then use the input from the controlling engine 120F of the autonomic business process platform 120 to collect data and/or metrics related to the specified variables characterizing the specified state.

In one example embodiment, the collecting engine 120A may operate based on the business and process objectives related to the dynamic work allocation system 110. Further, the collecting engine 120A may collect data and/or metrics related to mapping of jobs or tasks of outsourced business process to available pool of agents. In addition, the collecting engine 120A may collect data and/or metrics related to changes in the job or task status, during processing of the job or task by the agent within the outsourced business process. The collecting engine 120A may receive a request from the controlling engine 120F of the autonomic business process platform 120 to initiate actions which may include but not limited to collection of data and/or metrics related to the changing job or task status within the system.

Furthermore, the collecting engine 120A may raise a request on the controlling engine 120F to determine the data and/or metrics related to the changing job status which is relevant and important, based on business and process objectives. In one embodiment, the data related to the changing job status to be collected for the changing job status may include but not limited to number of jobs or tasks in each job or task status in the system, percentage of number of jobs or tasks in each job or task status in the system with respect to the total number of jobs or task in the system, etc.

The collecting engine 120A may operate based on the business rules related to the dynamic work allocation system 110 defined for the changing job or task status in the system. The business rules related to the dynamic work allocation system 110 for the changing job status in the system may include but not limited to percentage of jobs or tasks in a particular job or task status to be not more than a defined value, etc.

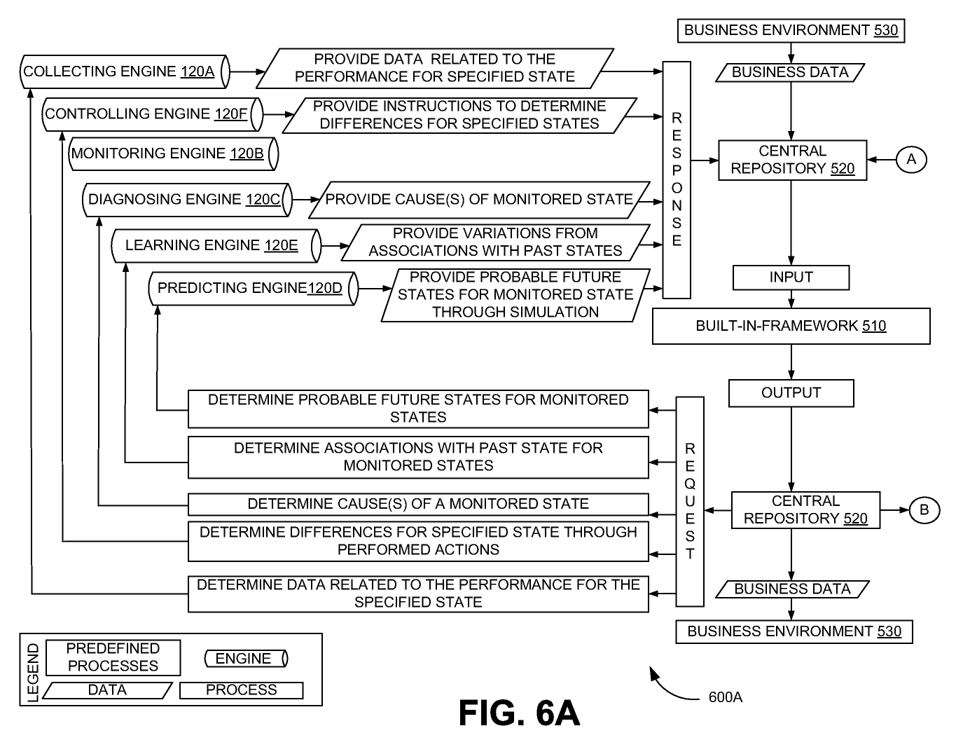

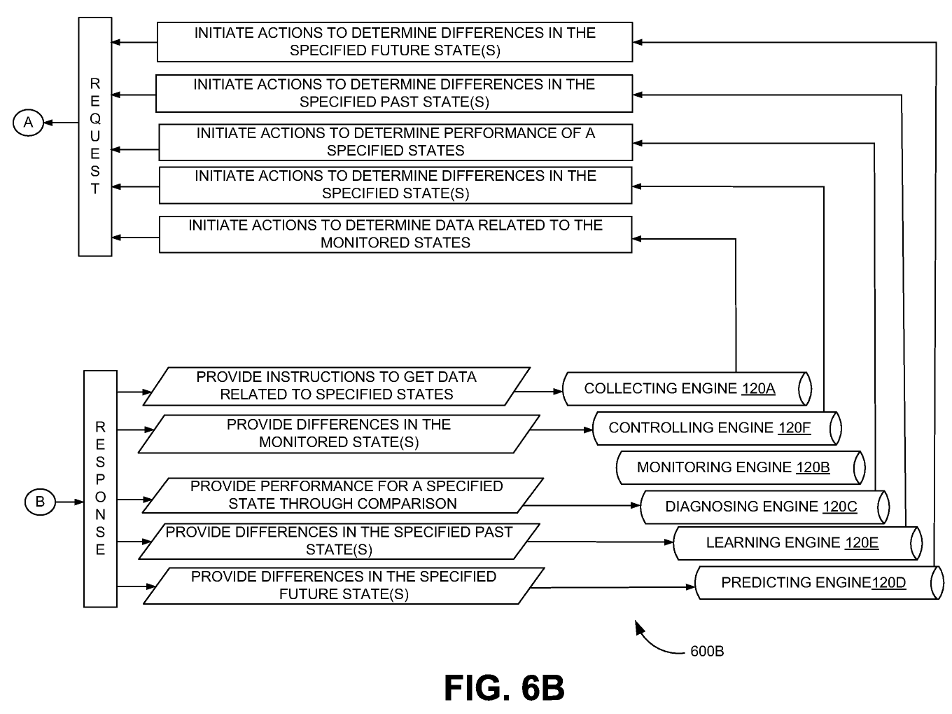

FIGS. 6A and 6B illustrate performance related to the monitoring engine 120B in the dynamic work allocation system 110 in relationship with other engines of the autonomic business process platform 120, according to one embodiment.

The monitoring engine 120B of the autonomic business process platform 120 enables automatic monitoring of the system, the resource, the process and/or the person based on the data and metrics related to the outsourced business process. The monitoring engine 120B compares a current state associated with a specific combination of the system, the resource, the process and the person with a desired state associated with a specific combination of the system, the resource, the process and the person, specified by the process environment 140. The thresholds in the business process are determined based on business objectives of the outsourced business process.

The monitoring engine 120B may operate through a rules-based method or any other method including but not limited to a neural network to determine process compliance, resource utilization and/or product performance. Based on these rules automatic, near real-time notifications are generated by the system. For example, the notifications may include but not limited to alerts on process deviations, pre-emptive alerts on possible process deviations, etc. The monitoring engine 120B may compare variables based on requests received from other engines of the autonomic business process platform 120.

Further, the monitoring engine 120B may use request of the collecting engine 120A of the autonomic business process platform 120 as an input to monitor specific variables characterizing a specified state, collect relevant data and metrics and monitor the specific variables against pre-determined thresholds of performance. The monitoring engine 120B may compare variables based on requests raised by the monitoring engine 120B on the other engines of the autonomic business process platform 120.

Further, the monitoring engine 120B may raise request on the collecting engine 120A of the autonomic business process platform 120 to determine relevant system, resource, process and/or person necessary to monitor a specified state. The monitoring engine 120B may then use input from the collecting engine 120A of the autonomic business process platform 120 to monitor the specified variables characterizing the specified state, collect the relevant data and metrics and monitor them against the pre-determined thresholds of performance.

For example, the monitoring engine 120B may operate based on business and process objectives related to the dynamic work allocation system 110. In one embodiment, the monitoring engine may monitor mapping of the jobs or tasks of the outsourced business process to available pool of agents. Further, the monitoring engine 120B may monitor changes in the job or task status during processing of the job or task by the agent within the outsourced business process. The monitoring engine 120B may receive a request from the collecting engine 120A of the autonomic business process platform 120 to initiate actions which may include but not limited to monitoring of data related to the changing job or task status within the system.

Further, the monitoring engine 120B may raise a request on the controlling engine 120F to determine data related to changing job status which is relevant and important based on business and process objectives. In one embodiment, the data related to the changing job status to be determined and monitored for the changing job status may include but not limited to number of jobs or tasks in each job or task status in the system, percentage of number of jobs or tasks in each job or task status in the system with respect to the total number of jobs or task in the system, etc.

The monitoring engine 120B may operate based on business rules related to the dynamic work allocation system 110 defined for the changing job or task status in the system. The business rules related to the dynamic work allocation system 110 for the changing job status in the system may include but not limited to percentage of jobs or tasks in a particular job or task status to be not more than a defined value, etc.

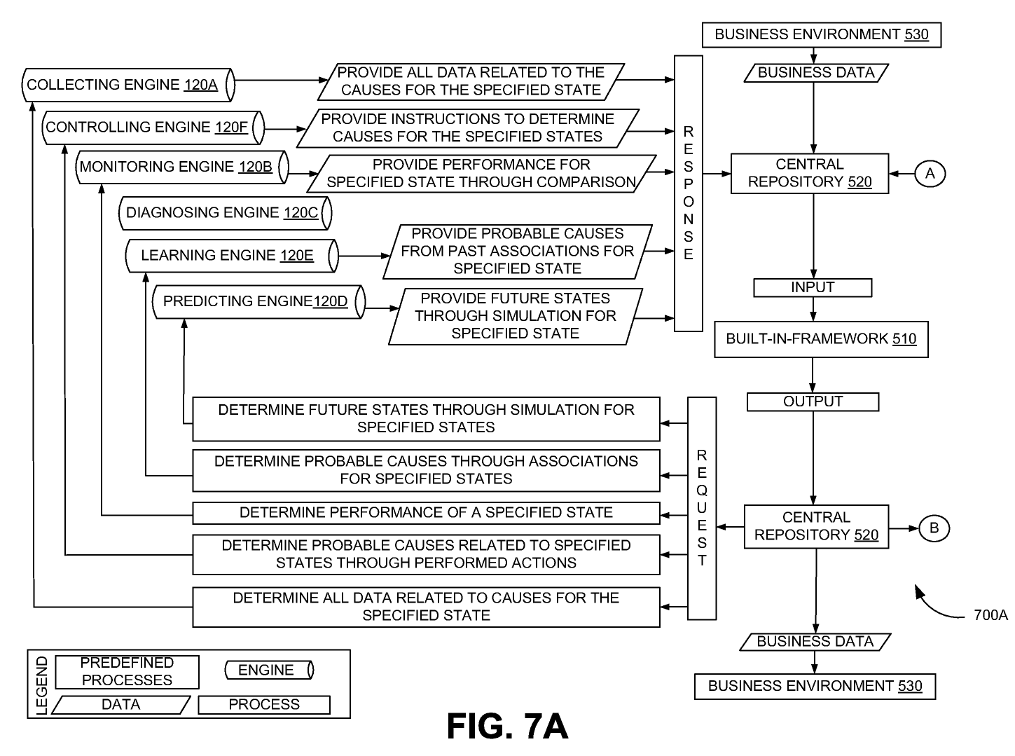

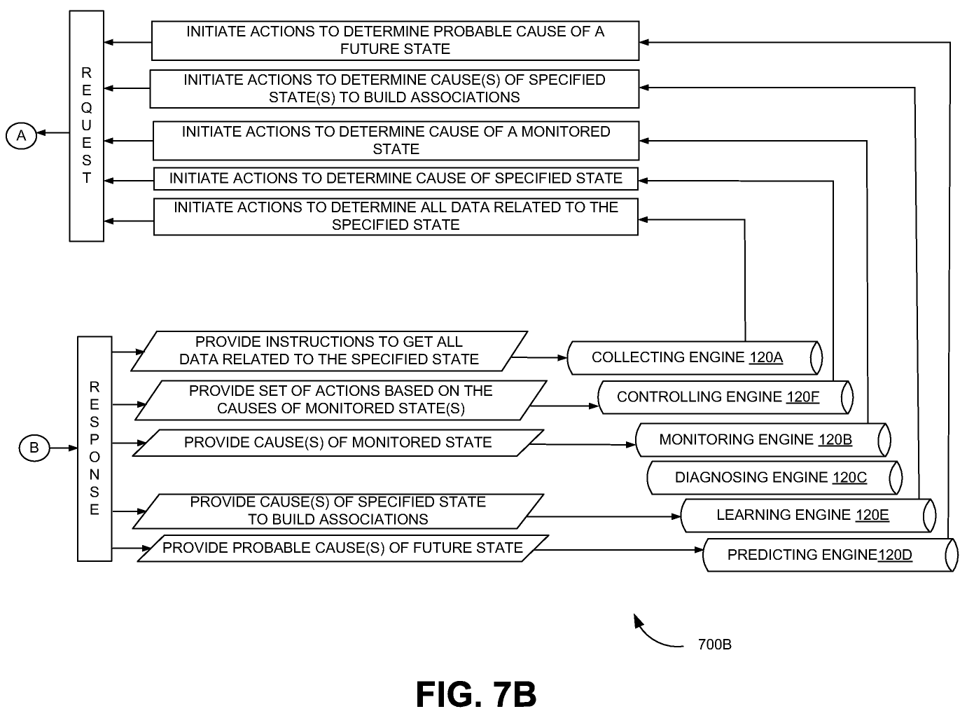

FIGS. 7A and 7B illustrate performance related to the diagnosing engine 120C in the dynamic work allocation system 110 in relationship with other engines of the autonomic business process platform 120, according to one embodiment.

The diagnosing engine 120C may determine reasons for occurrence of a specified state associated with a specific combination of the systems, the resources, the people and the processes. In some embodiments, the diagnosing engine 120C determines whether different systems, resources, processes and people are performing as per requirements of the business environment.

For example, the diagnosing engine 120C uses inputs from the collecting engine 120A and the monitoring engine 120B for the above determination. If it is determined that the performance is under par, corrective actions are taken. If it is determined that the performance is above par, cause of the increased efficiency is identified so that the identified causes can be repeated in future.

In one embodiment, the diagnosing engine 120C may use additional inputs from the predicting engine 120D and the learning engine 120E to improve upon the process of diagnosing. Furthermore, the outcome from the diagnosis process is disseminated to different engines of the autonomic business process platform 120. For example, the controlling engine 120F takes input from the diagnosing engine 120C to help determine actions needed to execute and manage the autonomic business platform 120 as per business environment requirements. Also, the predicting engine 120D and the learning engine 120E use the diagnosis to determine associations between different states and to better predict future states associated with the system, the resource, the process and/or the people.

The diagnosing engine 120C may determine reasons for occurrence of a specified state associated with a specific combination of the systems, the resources, the people and the processes based on requests received from other engines of the autonomic business process platform 120. Further, the diagnosing engine 120C may use request of the collecting engine 120A of the autonomic business process platform 120 as an input to determine reasons for occurrence of a specified state based on data provided by the collecting engine 120A.

The diagnosing engine 120C may determine reasons for occurrence of a specified state associated with a specific combination of the systems, the resources, the people and the processes based on requests raised by the diagnosing engine 120C on the other engines of the autonomic business process platform 120. Further, the diagnosing engine 120C may raise a request on the collecting engine 120A of the autonomic business process platform 120C to determine the data and/or metrics related to relevant system, resource, process and/or the person necessary to diagnose a specified state. The diagnosing engine 120C may then use the input from the collecting engine 120A of the autonomic business process platform 120 to determine reasons for occurrence of a specified state associated with a specific combination of the systems, the resources, the people and the processes.

For example, the diagnosing engine 120C may operate based on business and process objectives related to the dynamic work allocation system 110. In one embodiment, the diagnosing engine 120C may diagnose mapping of the jobs or tasks of the outsourced business process to the available pool of agents. Furthermore, the diagnosing engine 120C may determine reasons for changes in the job or task status during processing of the job or task by an agent within the outsourced business process.

The diagnosing engine 120C may receive a request from the collecting engine 120CA of the autonomic business process platform 120 to initiate actions which may include but not limited to diagnosing of data related to changing job or task status within the system. Furthermore, the diagnosing engine 120C may raise a request on the controlling engine 120F to determine data related to the changing job status which is relevant and important based on the business and process objectives.

In one embodiment, the data related to the changing job status to be determined and diagnosed for the changing job status may include but not limited to data inadequacy issues in processing of a particular job or task leading to change in status, completion of job or task as per requirements of the business process leading to change in status, etc.

The diagnosing engine 120C may operate based on business rules related to the dynamic work allocation system 110 defined for the changing job or task status in the system. The business rules related to the dynamic work allocation system 110 for the changing job status in the system may include but not limited to percentage of jobs or tasks in a particular job or task status to be not more than a defined value, etc.

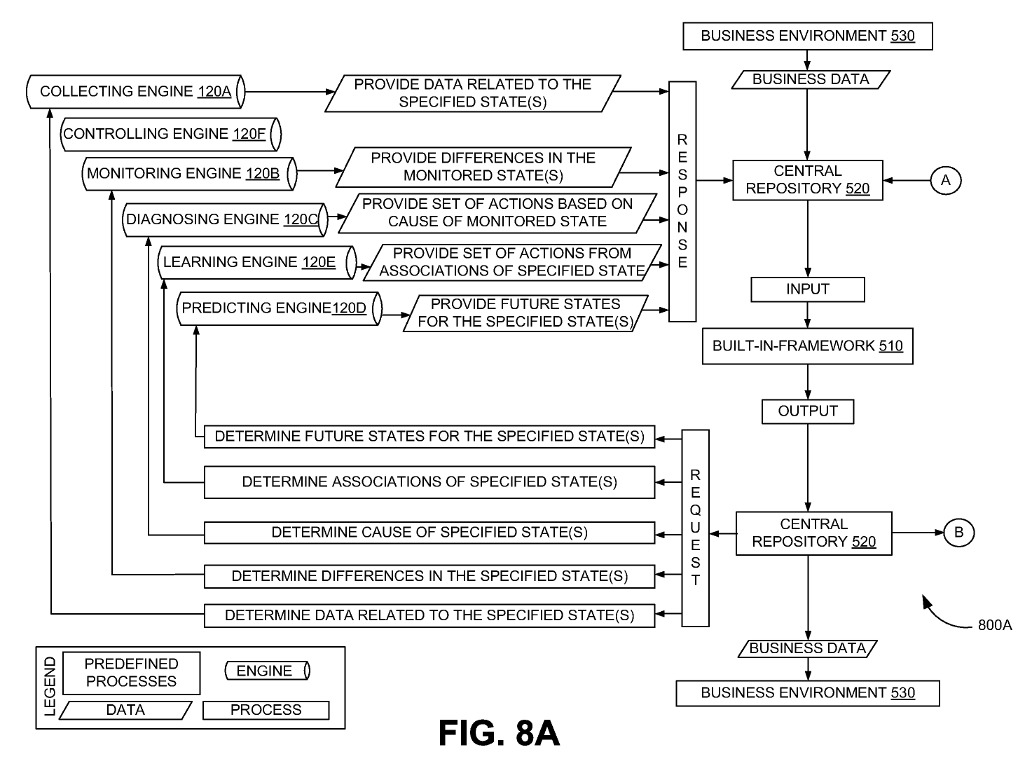

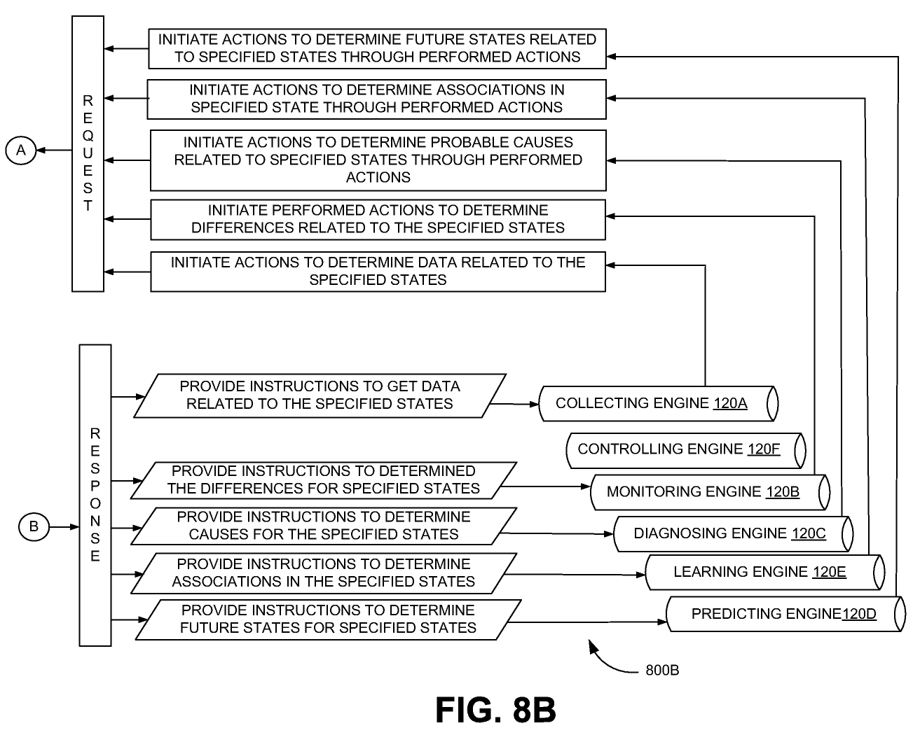

FIGS. 8A and 8B illustrate performance related to the controlling engine 120F in the dynamic work allocation system 110 in relationship with other engines of the autonomic business process platform 120, according to one embodiment.

The controlling engine 120F performs actions needed for a specific combination of the system, the resource, the process and/or the people to attain a desired state. The controlling is part or all of the controlling necessary and sufficient to determine a cause for current combination performance as specified by the business environment in which the autonomic business process platform 120 operates. In some embodiments, the collecting engine 120A and the monitoring engine 120B provide input to determine whether the combination performs as per business environment requirements.

Further, the diagnosing engine 120C may provide reasons for the combination to be in its current state. In one embodiment, the controlling engine 120F may use inputs from the learning engine 120E to determine multiple sets of actions that allows combination of the system, the resource, the process and/or the people to reach the desired state. The predicting engine 120D may simulate a set of actions determined by the controlling engine 120F to determine the effect of each set of actions. Further, combined set of inputs can be used by the controlling engine 120F to determine final set of actions to be executed to manage and maintain combination performance, and proactively correct deviations in the combination performance.

The controlling engine 120F may perform actions needed for a specific combination of the system, the resource, the process and/or the people to attain a desired state based on requests received from other engines of the autonomic business process platform 120. Further, the controlling engine 120F may use request of the collecting engine 120A of the autonomic business process platform 120 as an input to initiate actions to determine the data and/or metrics related to the specified state(s).

The controlling engine 120F may perform actions needed for a specific combination of the system, the resource, the process and/or the people to attain a desired state based on requests raised by the controlling engine 120F on the other engines of the autonomic business process platform 120. Further, the controlling engine 120F may raise request on the collecting engine 120A of the autonomic business process platform 120 to determine data and/or metrics related to relevant system, resource, process and/or person related to the specified state. The controlling engine 120F may then use the input from the collecting engine 120A of the autonomic business process platform 120 to perform actions to attain a desired state.

For example, the controlling engine 120F may operate based on business and process objectives related to the dynamic work allocation system 110. In one embodiment, the controlling engine 120F may perform actions related to mapping of the jobs or tasks of the outsourced business process to the available pool of agents. Furthermore, the controlling engine 120F may perform actions related to changes in the job or task status during the processing of the job or task by the agent within the outsourced business process.

The controlling engine 120F may receive a request from the collecting engine 120A of the autonomic business process platform 120 to initiate actions which may include but not limited to performing actions related to the changing job or task status within the system. Further, the controlling engine 120F may raise a request on the collecting engine 120A to determine data related to the changing job status which is relevant and important based on the business and process objectives. In one embodiment, the data related to the changing job status to be determined and diagnosed for the changing job status may include but not limited to data inadequacy issues in the processing of a particular job or task leading to change in status, completion of job or task as per requirements of the business process leading to change in status, etc.

The controlling engine 120F may operate based on the business rules related to the dynamic work allocation system 110 defined for the changing job or task status in the system. The business rules related to the dynamic work allocation system 110 for the changing job status in the system may include but not limited to percentage of jobs or tasks in a particular job or task status to be not more than a defined value, etc.

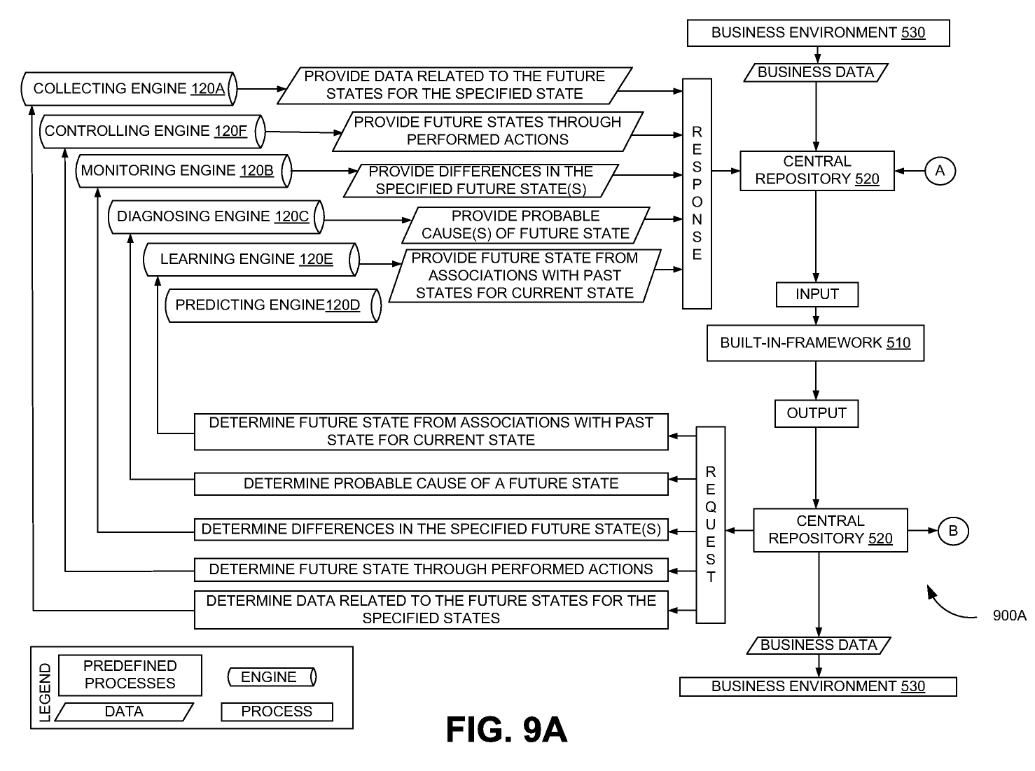

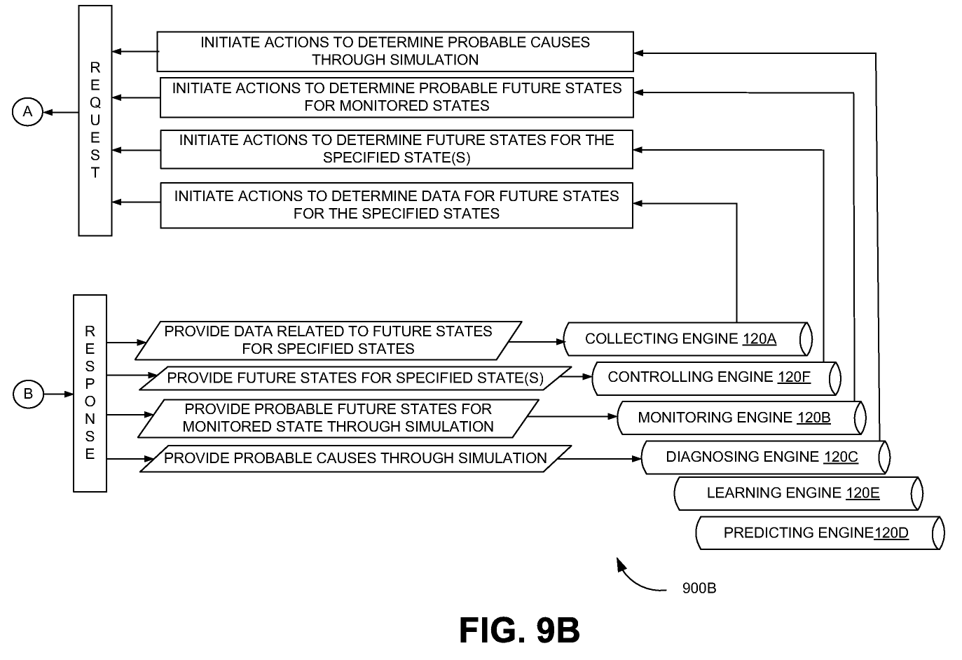

FIGS. 9A and 9B illustrate performance related to the predicting engine 120D in the dynamic work allocation system 110 in relationship with other engines of the autonomic business process platform 120, according to one embodiment.

The predicting engine 120D may perform a simulation to determine a future state of the combination of systems, resources, processes and/or people and use the predicted outcome to recommend actions for improved combination performance. The predicting is part or all of the predicting necessary and sufficient to determine the cause for the current combination performance as specified by the business environment in which the autonomic business process platform 120 operates. The collecting engine 120A and monitoring engine 120B provide input to the predicting engine 120D to determine current state of the combination, current combination performance and current set of actions being performed.

The diagnosing engine 120C may provide reasons for the current combination performance. The learning engine 120E may provide the predicting engine 120D with associations of past states that can lead to an improved prediction. In one embodiment, these inputs are used to predict the future state of the combination. In this embodiment, these sets of predictions can feed into the controlling engine 120F to determine the set of actions to be executed to maintain the desired level of combination performance and to proactively change state to correct process deviations. Further, these also feed into the learning engine 120E to determine correct associations and into the diagnosing engine 120C to determine the most probable diagnosis.

The predicting engine 120D may do a simulation to determine a future state of the combination of systems, resources, processes and/or people and use the predicted outcome to recommend actions for improved combination performance based on requests received from other engines of the autonomic business process platform 120. Further, the predicting engine 120D may use the request of the monitoring engine 120B of the autonomic business process platform 120 as an input to determine the future state based on the data provided by the monitoring engine 120B.

The predicting engine 120D may do a simulation to determine a future state of the combination of the systems, the resources, the processes and/or the people and use the predicted outcome to recommend actions for improved combination performance based on the requests raised by the predicting engine 120D on the other engines of the autonomic business process platform 120. Further, the predicting engine 120D may raise the request on the monitoring engine 120B of the autonomic business process platform 120 to determine the differences in the specified future states. The predicting engine 120D may then use the input from the monitoring engine 120B of the autonomic business process platform 120 to determine the future states and use the predicted outcome to recommend actions for improved performance of the combination of the systems, the resources, the people and the processes.

For example, the predicting engine 120D may operate based on the business and process objectives related to the dynamic work allocation system 110. In one embodiment, the predicting engine 120D may predict mapping of the jobs or tasks of the outsourced business process to the available pool of agents. Further, the predicting engine 120D may simulate future states according to the changes in the job or task status during the processing of the job or task by the agent within the outsourced business process. The predicting engine 120D may receive a request from the monitoring engine 120B of the autonomic business process platform 120 to initiate actions which may include but not limited to determining of probable future states related to the changing job or task status within the system.

Further, the predicting engine 120D may raise a request on the controlling engine 120F to provide future states through performed actions related to the changing job status which is relevant and important based on the business and process objectives. The predicting engine 120D may operate based on the business rules related to the dynamic work allocation system 110 defined for the changing job or task status in the system. The business rules related to the dynamic work allocation system 110 for the changing job status in the system may include but not limited to percentage of jobs or tasks in a particular job or task status to be not more than a defined value, etc.

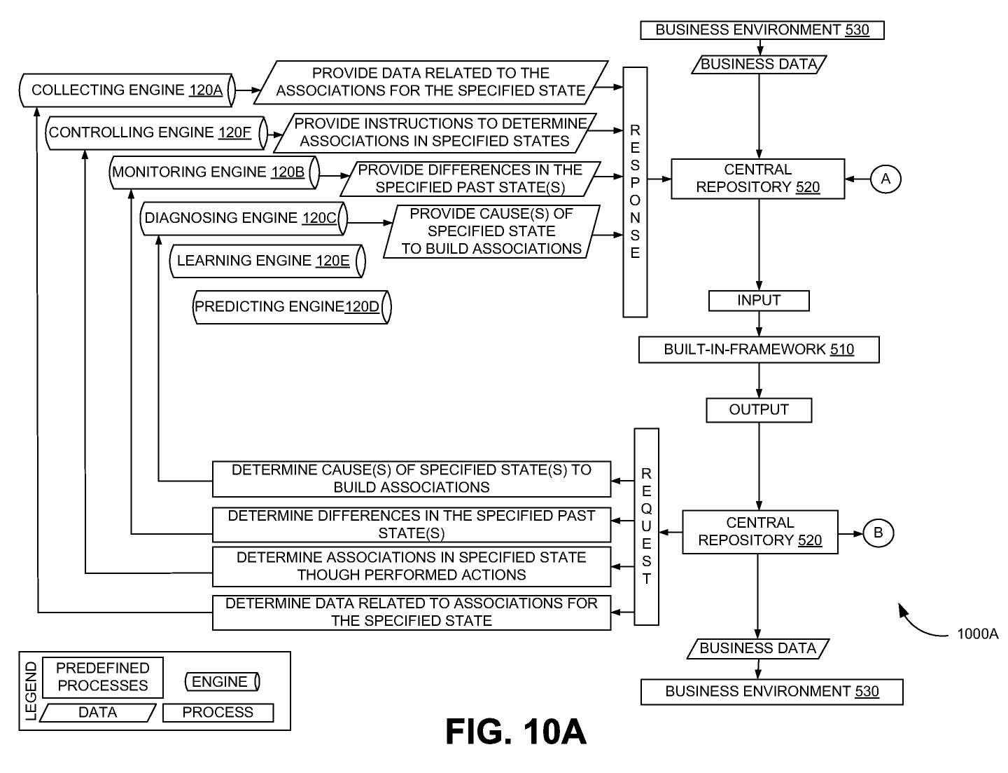

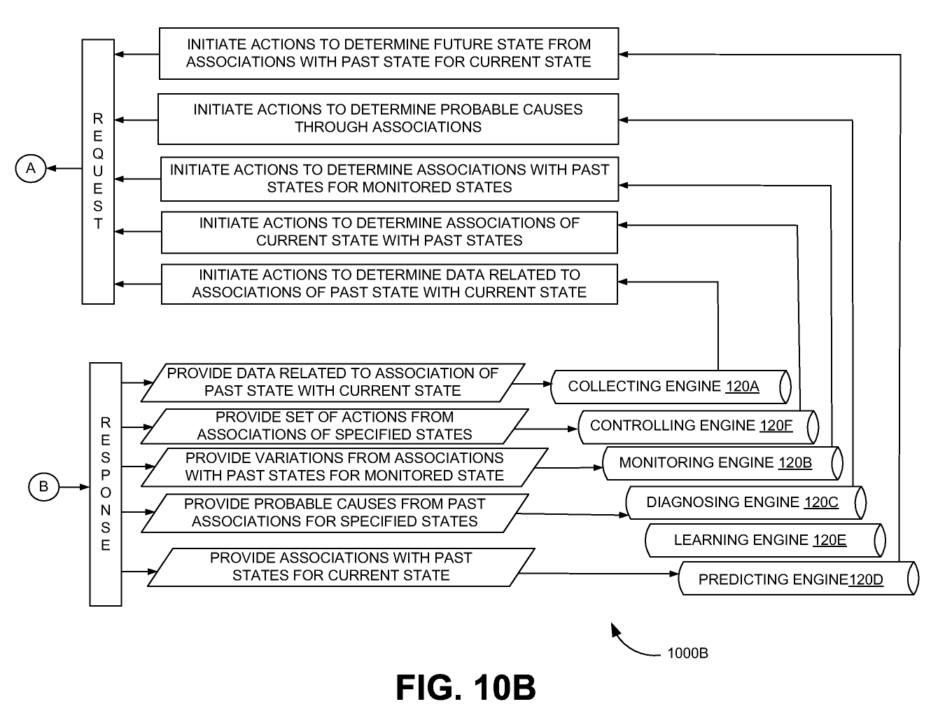

FIGS. 10A and 10B illustrate performance related to the learning engine 120E in the dynamic work allocation system 110 in relationship with other engines of the autonomic business process platform 120, according to one embodiment.

The learning engine 120E may determine associations between states of a combination of systems, resources, people and processes to help the processes perform as per business environment requirements. The learning is part or all of the learning necessary and sufficient to determine the cause for the current combination performance as specified by the business environment in which the autonomic business process platform 120 operates. The learning engine 120E uses data about past combination performance. In one embodiment, the collecting engine 120A and monitoring engine 120B provides input to determine current state of the combination, current combination performance and current set of actions being performed.

The diagnosing engine 120C may provide reasons for the current combination performance. The predicting engine 120D can provide the learning engine 120E with possible states against which the learning engine 120E may test its associations. These inputs may be used by the learning engine 120E to determine associations of past states that can lead to better combination performance. The learning engine 120E may determine associations between states of a combination of the systems, the resources, the people and the processes based on requests received from other engines of the autonomic business process platform 120.

Further, the learning engine 120E may use request of the collecting engine 120E of the autonomic business process platform 120 as an input to determine associations of past state with specified state based on data provided by the collecting engine 120E. The learning engine 120E may determine associations between states of a combination of the systems, the resources, the people and the processes based on requests raised by the learning engine 120E on the other engines of the autonomic business process platform 120. Further, the learning engine 120E may raise request on the collecting engine 120A of the autonomic business process platform 120 to determine the data and/or metrics related to the associations for the specified state.

The learning engine 120E may then use input from the collecting engine 120E of the autonomic business process platform 120 to determine associations between states of a specified state associated with a specific combination of the systems, the resources, the people and the processes. For example, the learning engine 120E may operate based on the business and process objectives related to the dynamic work allocation system 110. In one embodiment, the learning engine 120E may determine associations related to various states related to mapping of the jobs or tasks of the outsourced business process to the available pool of agents.

Further, the learning engine 120E may determine associations for the changes in the job or task status during the processing of the job or task by the agent within the outsourced business process. The learning engine 120E may receive a request from the collecting engine 120A of the autonomic business process platform 120 to initiate actions which may include but not limited to determining of associations between states related to the changing job or task status within the system. Further, the learning engine 120E may raise a request on the collecting engine 120A to determine the data related to the changing job status which is relevant and important based on the business and process objectives.

In one embodiment, the data related to the changing job status to be determined and diagnosed for the changing job status may include but not limited to data inadequacy issues in processing of a particular job or task leading to change in status, completion of job or task as per requirements of the business process leading to change in status, etc. The learning engine 120E may operate based on the business rules related to the dynamic work allocation system 110 defined for the changing job or task status in the system. The business rules related to the dynamic work allocation system 110 for the changing job status in the system may include but not limited to percentage of jobs or tasks in a particular job or task status to be not more than a defined value, etc.

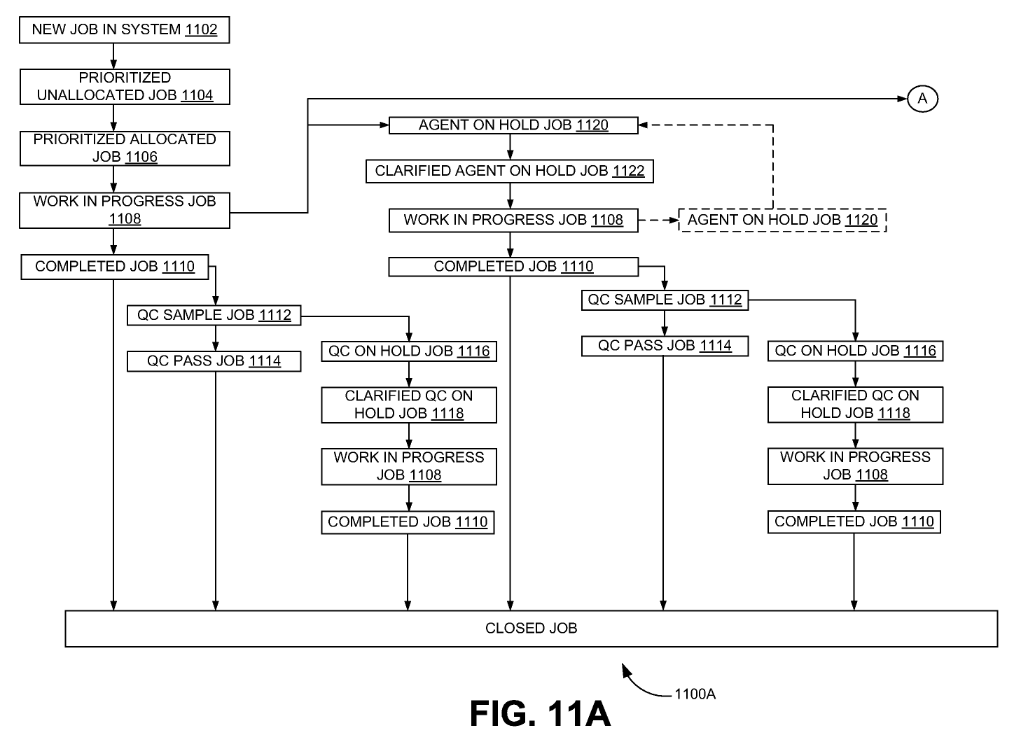

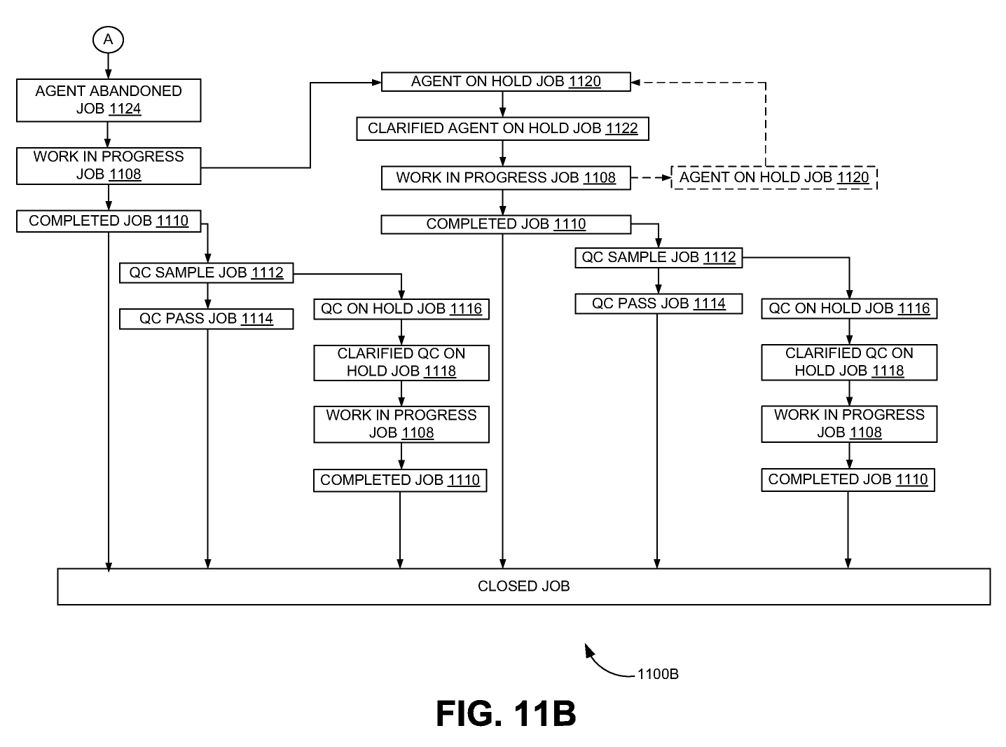

FIGS. 11A and 11B are block diagrams illustrating different job/task status in the system, according to one embodiment. In some embodiments, the jobs or tasks in the system undergo a number of changes in its status while being processed in the system. The number of different changes in the job status apart from other inputs from various sources forms a critical input to the dynamic work allocation system 110. Further, only jobs with status such as available are allocated to available agent pool for a specified business process in the dynamic work allocation system 110.

For example, the job or task status may include prioritized unallocated job 1104, prioritized allocated job 1106, work in progress job 1108, QC sample job 1112, clarified QC on-hold job 1118, clarified agent on-hold job 1122, agent abandoned job 1124, etc. In the example embodiment illustrated in FIG. 11, new jobs 1102 that are to be processed enter the system and leave the system as completed jobs 1110. The new jobs or tasks that enter the system as prioritized unallocated jobs 1104 are allocated to appropriate agents from the agent pool. In some embodiments, distribution of the jobs to the agents is enabled through a pull system, where the agents pull a job (from the common prioritized job set), for which the agents are capable and authorized to perform.

Further, it can be seen from FIG. 11 that the status changes from that of prioritized allocated job 1106, to that of work in progress job 1108, as the job gets processed in the system. In one embodiment, the status of the job changes from work in progress 1108 to completed job 1110 and then to closed job. Further, the status of the job may change from that of completed job 1110 to QC sample job 1112 and QC pass job 1114 and then to closed job. Also, from the job status QC sample job 1112, the status may change to that of QC on hold job 1116, clarified QC on hold job 1118, work in progress job 1108, completed job 1110 and then to closed job, as illustrated in FIG. 11.

In another embodiment, the status changes from that of work in progress 1108 to that of agent on hold job 1120, clarified agent on hold job 1122, work in progress job 1108, then to completed job 1110 and to closed job. It can be noted here that the job status changes from completed job 1100 to other job status as shown in FIG. 11. Also, the status may change back to that of agent on hold job 1120 from that of work in progress job 1108. In yet another embodiment, the status changes from work in progress 1108 to agent abandoned job 1124. Further, the status changes to the different status described above and finally attain the closed job status.

In some embodiments, the identification of job status enables in priority tagging of the jobs and correct mapping of jobs to agents. Further, the identification of job status feeds in as input to the diagnosing engine 120C, the predicting engine 120D and the learning engine 120E. For example, the diagnosing engine 120C uses such identification of status as an input to identify the positive and negative reasons for the change. This analysis feeds into predicting engine 120D and/or the learning engine 120E to allow the system to learn and predict plausible future outcomes.

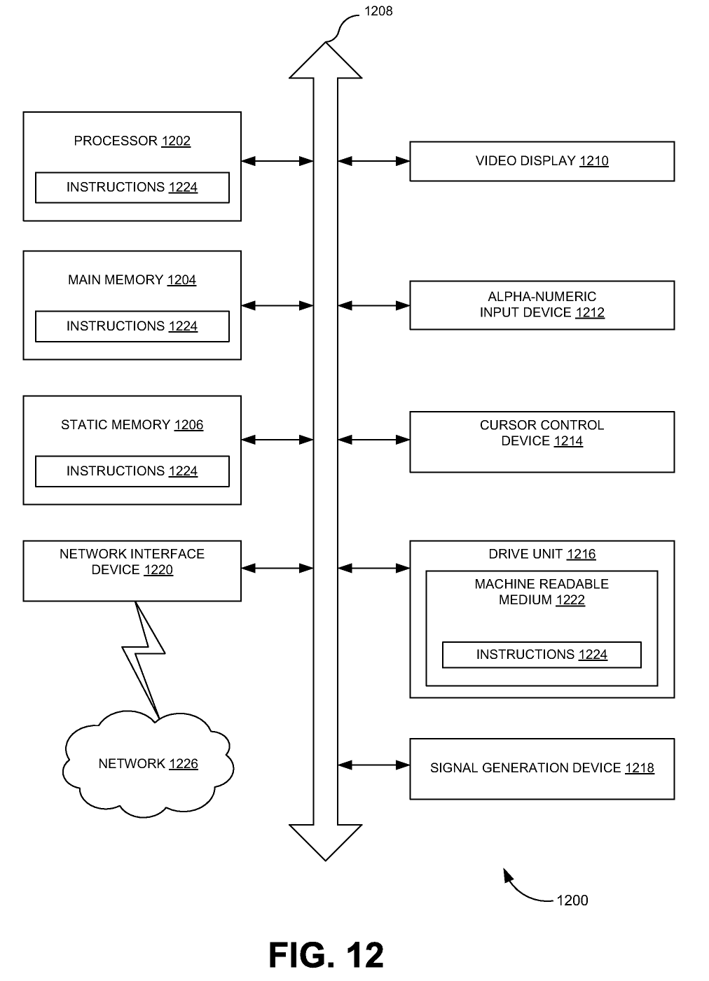

FIG. 12 illustrates a diagrammatic system view 1200 of a data processing system in which any of the embodiments disclosed herein may be performed, according to one embodiment. Particularly, the diagrammatic system view of FIG. 12 illustrates a processor 1202, a main memory 1204, a static memory 1206, a bus 1208, a video display 1210, an alpha-numeric input device 1212, a cursor control device 1214, a drive unit 1216, a signal generation device 1218, a network interface device 1220, a machine readable medium 1222, instructions 1224 and a network 1226.

The diagrammatic system view 1200 may indicate a personal computer and/or a data processing system in which one or more operations disclosed herein are performed. The processor 1202 may be a microprocessor, a state machine, an application specific integrated circuit, a field programmable gate array, etc. The main memory 1204 may be a dynamic random access memory and/or a primary memory of a computer system. The static memory 1206 may be a hard drive, a flash drive, and/or other memory information associated with the data processing system.

The bus 1208 may be an inter-connection between various circuits and/or structures of the data processing system. The video display 1210 may provide graphical representation of information on the data processing system. The alpha-numeric input device 1212 may be a keypad, keyboard and/or any other input device of text (e.g., a special device to aid the physically handicapped). The cursor control device 1214 may be a pointing device such as a mouse. The drive unit 1216 may be a hard drive, a storage system, and/or other longer term storage subsystem.

The signal generation device 1218 may be a bios and/or a functional operating system of the data processing system. The network interface device 1220 may perform interface functions (e.g., code conversion, protocol conversion, and/or buffering) required for communications to and from the network 1226 between a number of independent devices (e.g., of varying protocols). The machine readable medium 1222 may provide instructions on which any of the methods disclosed herein may be performed. The instructions 1224 may provide source code and/or data code to the processor 1202 to enable any one or more operations disclosed herein.

For example, a storage medium having instructions, that when executed by a computing platform, result in execution of a method of dynamically allocating work in a data processing system, including dynamically classifying jobs into job lists according to a predetermined classifying process by the collecting engine 120A, the controlling engine 120F, and the monitoring engine 120B, dynamically prioritizing the jobs within each job list of the jobs lists into an ordered job list according to a predetermined prioritizing process by the collecting engine 120A, the controlling engine 120F, the monitoring engine 120B, the diagnosing engine 120C, the learning engine 120E, and the predicting engine 120D, and dynamically mapping the jobs in the ordered job lists to agents according to a predetermined mapping process by the collecting engine 120A, the controlling engine 120F, the monitoring engine 120B, the diagnosing engine 120C, the learning engine 120E, and the predicting engine 120D.

The storage medium may have instructions to dynamically collect at least one of at least one job of the jobs and information associated with at least one job of the jobs by the collecting engine 120A and the controlling engine 120F. The storage medium may also have instructions to dynamically identify a status (e.g., a completed job, a work in progress job, a new job, a quality checked job, a quality check in progress job, a quality pass job, a quality failed job, a rework job, and a reject job) associated with each job of the jobs by the collecting engine 120A, the controlling engine 120F, and the monitoring engine 120B, and based at least in part on the statuses, to dynamically prioritize the jobs within each job list of the jobs lists into the ordered job list according to a predetermined prioritizing process by the collecting engine 120A, the controlling engine 120F, the monitoring engine 120B, the diagnosing engine 120C, the learning engine 120E, and the predicting engine 120D.

Further, the storage medium may have instructions to dynamically determine availability of each agent of the agents, and based at least in part on the availability of the agents, to dynamically map the jobs in the ordered job lists to agents according to the predetermined mapping process by the collecting engine 120A, the controlling engine 120F, the monitoring engine 120B, the diagnosing engine 120C, the learning engine 120E, and the predicting engine 120D.

For example, the dynamically mapping the jobs in the ordered job lists to agents according to the predetermined mapping process by the collecting engine 120A, the controlling engine 120F, the monitoring engine 120B, the diagnosing engine 120C, the learning engine 120E, and the predicting engine 120D includes dynamically identifying an authorization matrix for an agent of the agents, and dynamically allocating at least one job of the jobs to an agent of the agents based on the authorization matrix for the agent of the agents.

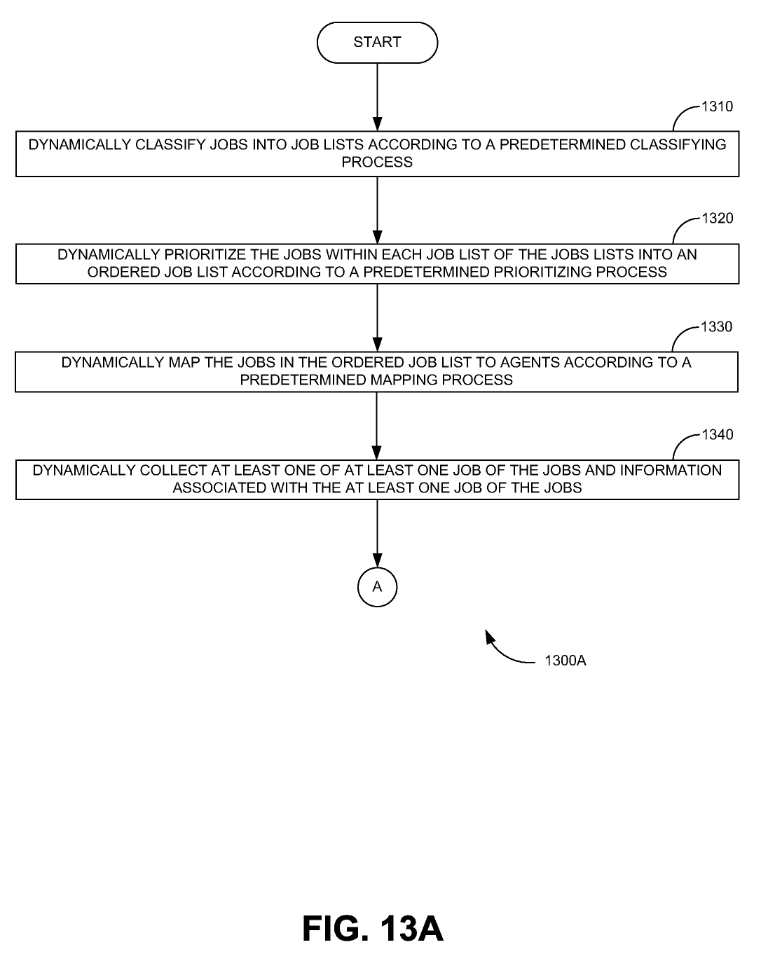

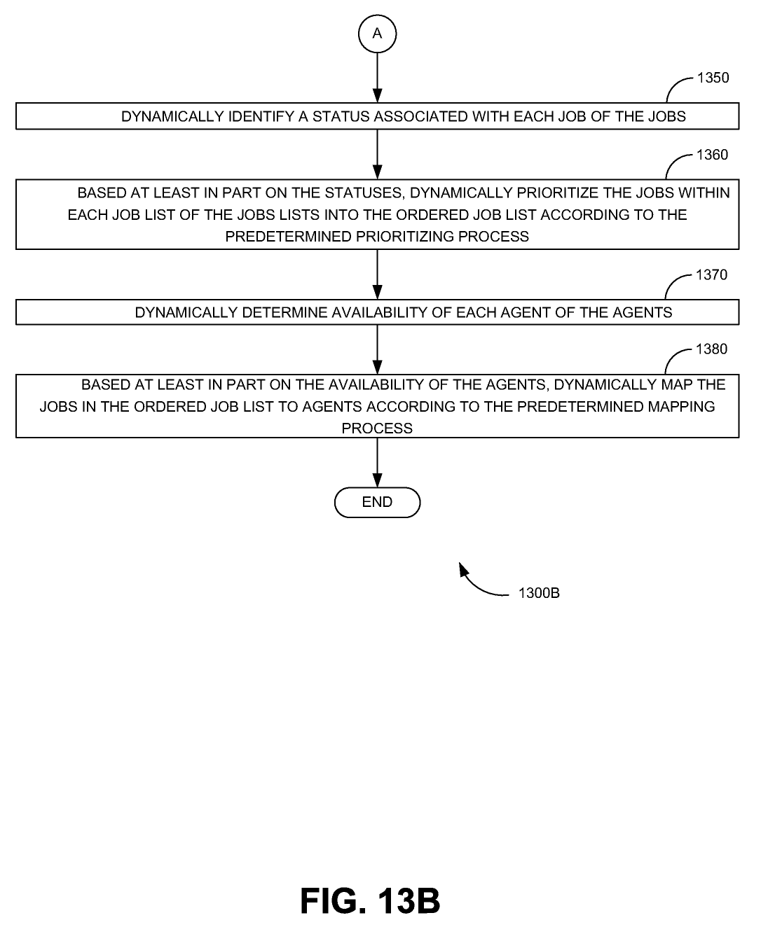

FIG. 13A is a process flow of dynamically allocating work in a data processing system, according to one embodiment. In operation 1310, jobs are dynamically classified into job lists according to a predetermined classifying process by a collecting engine 120A, a controlling engine 120F, and a monitoring engine 120B. In operation 1320, the jobs are dynamically prioritized within each job list of the jobs lists into an ordered job list according to a predetermined prioritizing process by the collecting engine 120A, the controlling engine 120F, the monitoring engine 120B, a diagnosing engine 120C, a learning engine 120E, and a predicting engine 120D.

In operation 1330, the jobs in the ordered job list are dynamically mapped to agents according to a predetermined mapping process by the collecting engine 120A, the controlling engine 120F, the monitoring engine 120B, the diagnosing engine 120C, the learning engine 120E, and the predicting engine 120D. In operation 1340, a job of the jobs and/or information associated with the job is dynamically collected by the collecting engine 120A and the controlling engine 120F.

FIG. 13B is continuation of the process flow of FIG. 13A, illustrating additional processes, according to one embodiment. In operation 1350, a status associated with each job of the jobs is dynamically identified by the collecting engine 120A, the controlling engine 120F, and the monitoring engine 120B. For example, the status may include a completed job, a work in progress job, a new job, a quality checked job, a quality check in progress job, a quality pass job, a quality failed job, a rework job, and a reject job. In operation 1360, based at least in part on the statuses, the jobs within each job list of the jobs lists are dynamically prioritized into the ordered job list according to the predetermined prioritizing process by the collecting engine 120A, the controlling engine 120F, the monitoring engine 120B, the diagnosing engine 120C, the learning engine 120E, and the predicting engine 120D.

In operation 1370, availability of each agent of the agents is dynamically determined. In operation 1380, based at least in part on the availability of the agents, the jobs in the ordered job list are dynamically mapped to agents according to the predetermined mapping process by the collecting engine 120A, the controlling engine 120F, the monitoring engine 120B, the diagnosing engine 120C, the learning engine 120E, and the predicting engine 120D.

In some embodiments, the dynamically mapping the jobs in the ordered job list to agents according to the predetermined mapping process by the collecting engine 120A, the controlling engine 120F, the monitoring engine 120B, the diagnosing engine 120C, the learning engine 120E, and the predicting engine 120D includes dynamically identifying an authorization matrix for an agent of the agents, and dynamically allocating a job of the jobs to an agent of the agents based on the authorization matrix for the agent of the agents.

For example, the dynamically identifying an authorization matrix for an agent of the agents includes dynamically identifying a team associated with the agent of the agents, dynamically ascertaining team eligibility of a process (e.g., includes processes, subprocesses and categories) and dynamically identifying a process role assigned to the agent of the agents. The dynamically allocating a job of the jobs to an agent of the agents based on the authorization matrix for the agent of the agents includes dynamically pulling, via an authorized agent of the agents, an allocated job of the jobs, and dynamically generating a list of jobs on which the agent of the agents is authorized to work, based on the authorization matrix associated with the agent of the agents and current prioritized jobs.

Further, the dynamically generating a list of jobs on which the agent of the agents is authorized to work, based on the authorization matrix associated with the agent of the agents and the current prioritized jobs includes dynamically determining which job in the list of jobs has a highest priority associated with a priority tag of the job in the jobs list.

The above-described technique uses computational technique to provide a measurable and scientific methodology to arrive at the optimal job allocation. Further, the above-described system has built in capability of adjusting to the changing realities (e.g., inflow of new jobs to the floor) changes in availability of agents and unpredictable request from the client organization to process certain jobs out of queue.

In addition, the above-described system can be integrated with other enterprise systems to gather critical information on system, process, people and resources. This allows the algorithm to operate in the current reality of the process and leverage on any productivity and/or competence improvement that has taken place in the floor. As jobs get executed, critical execution parameters such as wait times, average handling times, turn-around times, number and type of errors, and productivity and capability data of agents are captured and fed back into the allocation algorithm for optimal allocation.

The above-described system depicts a pull system being implemented with the agents pulling jobs from the common pool of prioritized job set as and when required instead of the system pushing the jobs into agent job queues for processing.

Although the present embodiments have been described with reference to specific example embodiments, it will be evident that various modifications and changes may be made to these embodiments without departing from the broader spirit and scope of the various embodiments.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
dynamically classifying jobs into job lists according to a predetermined classifying process by an element selected from the group consisting essentially of a collecting engine, a controlling engine, and a monitoring engine;
dynamically prioritizing the jobs within each job list of the jobs lists into an ordered job list according to a predetermined prioritizing process by an element selected from the group consisting essentially of a collecting engine, a controlling engine, a monitoring engine, a diagnosing engine, a learning engine, and a predicting engine; and
dynamically mapping the jobs in the ordered job list to agents according to a predetermined mapping process by an element selected from the group consisting essentially of a collecting engine, a controlling engine, a monitoring engine, a diagnosing engine, a learning engine, and a predicting engine.

2. The method of claim 1, further comprising:
dynamically collecting at least one of at least one job of the jobs and information associated with the at least one job of the jobs by an element selected from the group consisting essentially of a collecting engine and a controlling engine.

3. The method of claim 1, further comprising:
dynamically identifying a status associated with each job of the jobs by an element selected from the group consisting essentially of a collecting engine, a controlling engine, and a monitoring engine; and
based at least in part on the statuses, dynamically prioritizing the jobs within each job list of the jobs lists into the ordered job list according to the predetermined prioritizing process by an element selected from the group consisting essentially of a collecting engine, a controlling engine, a monitoring engine, a diagnosing engine, a learning engine, and a predicting engine.

4. The method of claim 3, wherein the status comprises at least one element selected from the group consisting essentially of a completed job, a work in progress job, a new job, a quality checked job, a quality check in progress job, a quality pass job, a quality failed job, a rework job, and a reject job.

5. The method of claim 1, further comprising:
dynamically determining availability of each agent of the agents; and
based at least in part on the availability of the agents, dynamically mapping the jobs in the ordered job list to agents according to the predetermined mapping process by an element selected from the group consisting essentially of the collecting engine, the controlling engine, the monitoring engine, a diagnosing engine, a learning engine, and a predicting engine.

6. The method of claim 1, wherein the dynamically mapping the jobs in the ordered job list to agents according to the predetermined mapping process by an element selected from the group consisting essentially of a collecting engine, a controlling engine, a monitoring engine, a diagnosing engine, a learning engine, and a predicting engine comprises:
dynamically identifying an authorization matrix for an agent of the agents; and
dynamically allocating at least one job of the jobs to an agent of the agents based on the authorization matrix for the agent of the agents.

7. The method of claim 6, wherein the dynamically identifying an authorization matrix for an agent of the agents comprises:
dynamically identifying a team associated with the agent of the agents;
dynamically ascertaining team eligibility of a process; and
dynamically identifying a process role assigned to the agent of the agents.

8. The method of claim 6, wherein the dynamically allocating at least one job of the jobs to an agent of the agents based on the authorization matrix for the agent of the agents comprises:
dynamically pulling, via an authorized agent of the agents, an allocated job of the jobs; and
dynamically generating a list of jobs on which the agent of the agents is authorized to work, based on the authorization matrix associated with the agent of the agents and current prioritized jobs.

9. The method of claim 8, wherein the dynamically generating a list of jobs on which the agent of the agents is authorized to work, based on the authorization matrix associated with the agent of the agents and the current prioritized jobs comprises:
dynamically determining which job in the list of jobs has a highest priority associated with a priority tag of the job in the jobs list.

10. The method of claim 1 in a form of a machine-readable medium embodying a set of instructions that, when executed by a machine, causes the machine to perform the method of claim 1.

11. A system comprising:
a job classification module to dynamically classify jobs into job lists according to a predetermined classifying process by an element selected from the group consisting essentially of a collecting engine, a controlling engine, and a monitoring engine;
a job prioritization module to dynamically prioritize the jobs within each job list of the jobs lists into an ordered job list according to a predetermined prioritizing process by an element selected from the group consisting essentially of a collecting engine, a controlling engine, a monitoring engine, a diagnosing engine, a learning engine, and a predicting engine; and
a job mapping module to dynamically map the jobs in the ordered job lists to agents according to a predetermined mapping process by an element selected from the group consisting essentially of a collecting engine, a controlling engine, a monitoring engine, a diagnosing engine, a learning engine, and a predicting engine.

12. The system of claim 11, further comprising:
a job collection module to dynamically collect at least one of at least one job of the jobs and information associated with at least one job of the jobs by an element selected from the group consisting essentially of a collecting engine and a controlling engine.

13. The system of claim 11, further comprising:
a status identification module to dynamically identify a status associated with each job of the jobs by an element selected from the group consisting essentially of a collecting engine, a controlling engine, and a monitoring engine; and
a status prioritization module to, based at least in part on the statuses, dynamically prioritize the jobs within each job list of the jobs lists into the ordered job list according to the predetermined prioritizing process by an element selected from the group consisting essentially of a collecting engine, a controlling engine, a monitoring engine, a diagnosing engine, a learning engine, and a predicting engine.

14. The system of claim 13, wherein the status comprises at least one element selected from the group consisting essentially of: a completed job, a work in progress job, a new job, a quality checked job, a quality check in progress job, a quality pass job, a quality failed job, a rework job, and a reject job.

15. The system of claim 11, further comprising:
an availability determination module to dynamically determine availability of each agent of the agents; and
an availability mapping module to, based at least in part on the availability of the agents, dynamically map the jobs in the ordered job lists to agents according to the predetermined mapping process by an element selected from the group consisting essentially of a collecting engine, a controlling engine, a monitoring engine, a diagnosing engine, a learning engine, and a predicting engine.

16. The system of claim 15, wherein the availability mapping module comprises:
an authorization matrix identification module to dynamically identify an authorization matrix for an agent of the agents; and
a job allocation module to dynamically allocate at least one job of the jobs to an agent of the agents based on the authorization matrix for the agent of the agents.

17. The system of claim 16, wherein the authorization matrix identification module comprises:
a team identification module to dynamically identify a team associated with the agent of the agents;
a team eligibility module to dynamically ascertain team eligibility of a process, a sub-process, and a category; and
a process role identification module to dynamically identify a process role assigned to the agent of the agents.

18. The system of claim 16, wherein the job allocation module comprises:
a job pull module to dynamically pull, via an authorized agent of the agents, an allocated job of the jobs; and
a job list generation module to dynamically generate a list of jobs on which the agent of the agents is authorized to work, based on the authorization matrix associated with the agent of the agents and current prioritized jobs.

19. The system of claim 18, wherein the job list generation module comprises:
a highest priority determination module to dynamically determine which job in the list of jobs has a highest priority associated with a priority tag of the job in the jobs list.

20. An article, comprising:
a storage medium having instructions, that when executed by a computing platform, result in execution of a method of dynamically allocating work in a data processing system, comprising:
dynamically classifying jobs into job lists according to a predetermined classifying process by an element selected from the group consisting essentially of a collecting engine, a controlling engine, and a monitoring engine;
dynamically prioritizing the jobs within each job list of the jobs lists into an ordered job list according to a predetermined prioritizing process by an element selected from the group consisting essentially of a collecting engine, a controlling engine, a monitoring engine, a diagnosing engine, a learning engine, and a predicting engine; and
dynamically mapping the jobs in the ordered job lists to agents according to a predetermined mapping process by an element selected from the group consisting essentially of a collecting engine, a controlling engine, a monitoring engine, a diagnosing engine, a learning engine, and a predicting engine.

21. The article of claim 20, further comprising:
dynamically collecting at least one of at least one job of the jobs and information associated with at least one job of the jobs by an element selected from the group consisting essentially of a collecting engine and a controlling engine.

22. The article of claim 20, further comprising:
dynamically identifying a status associated with each job of the jobs by an element selected from the group consisting essentially of a collecting engine, a controlling engine, and a monitoring engine; and
based at least in part on the statuses, dynamically prioritizing the jobs within each job list of the jobs lists into the ordered job list according to a predetermined prioritizing process by an element selected from the group consisting essentially of a collecting engine, a controlling engine, a monitoring engine, a diagnosing engine, a learning engine, and a predicting engine.

23. The article of claim 22, wherein the status comprises at least one element selected from the group consisting essentially of a completed job, a work in progress job, a new job, a quality checked job, a quality check in progress job, a quality pass job, a quality failed job, a rework job, and a reject job.

24. The article of claim 20, further comprising
dynamically determining availability of each agent of the agents; and
based at least in part on the availability of the agents, dynamically mapping the jobs in the ordered job lists to agents according to the predetermined mapping process by an element selected from the group consisting essentially of a collecting engine, a controlling engine, a monitoring engine, a diagnosing engine, a learning engine, and a predicting engine.

25. The article of claim 20, wherein the dynamically mapping the jobs in the ordered job lists to agents according to the predetermined mapping process by an element selected from the group consisting essentially of a collecting engine, a controlling engine, a monitoring engine, a diagnosing engine, a learning engine, and a predicting engine comprises:
dynamically identifying an authorization matrix for an agent of the agents; and
dynamically allocating at least one job of the jobs to an agent of the agents based on the authorization matrix for the agent of the agents.
